(19) United States
(12) Patent Application Publication
(10) Pub. No.: US 2013/0046712 A1
(43) Pub. Date: Feb. 21, 2013

(54) FRACTIONAL MEDIA SALES

(71) Applicant: Jordan S. Bernhard, Santa Monica, CA (US)

(72) Inventor: Jordan S. Bernhard, Santa Monica, CA (US)

(73) Assignee: Jordan CreativeWorks, LLC, Santa Monica, CA (US)

(21) Appl. No.: 13/553,059

(22) Filed: Jul. 19, 2012

Related U.S. Application Data
(60) Provisional application No. 61/524,849, filed on Aug. 18, 2011.

(51) Int. Cl. G06Q 90/00

(52) U.S. Cl. 705/500

(57) ABSTRACT

Methods of selling or offering for sale at least one unaltered duplicate part of print media, such as from a magazine or newspaper, separate to that which is otherwise dispensed or offered for sale as a combined multi-part unit.

### CROSS REFERENCE TO RELATED APPLICATIONS

This non-provisional patent application claims priority and the benefit from U.S. Provisional Patent Application No. 61/524,849, filed Aug. 18, 2011, the entire disclosure of which is hereby incorporated by reference.

### FIELD OF THE INVENTION

The present invention generally relates to printed media and more particularly, to methods of producing and selling unaltered printed copies of specific parts of print media without having to purchase the whole printed publication.

### BACKGROUND

Media producers regularly publish multi-part printed matter, such as newspapers, which are comprised of individual sections (Front Page, Business, Health, Opinion, etc.) bundled together to form a combined multi-part or multiple-section unit. These units are then sold or offered for sale directly to consumers or subscribers “on the street” who pay a fixed amount for the undivided unit. Similarly, other media producers publish printed matter like books and magazines that contain different articles, chapters or sections, each bound together into single combined work which is then sold or offered for sale directly to consumers or subscribers (hereinafter to include the meaning of “on the street”) who pay a fixed amount, again for the whole undivided unit.

Some media producers also publish condensed supplements that generally contain recaps of specific highlights from a given time period. However, these supplements differ in many ways to include changes in layout and wording that is wholly dissimilar to the content first sold or otherwise offered for sale in its combined form. Each supplement is therefore entirely new and materially distinct.

Computer users can view, download or sometime print copies of content from publications if available online. However, the content is necessarily different in such “virtual” electronic format when compared to the actual physical printed form being sold or offered for sale directly to consumers or subscribers.

What does not exist for these multi-part printed publications is a way for consumers or subscribers to acquire unaltered printed copies of specific parts (e.g., just today's Sports section) without having to purchase the whole printed publication.

Accordingly, there is a need for a method to produce and commercialize unaltered duplicate copies of at least one part of a multi-part printed publication, such as a magazine or newspaper, separate from that that which is regularly sold as a combined multi-part printed unit whose parts are not intended for individual sale. Such approach is referred to herein as “Fractional Media”.

The foregoing discussion is intended only to illustrate various aspects of the related art in the field of the invention at the time, and should not be taken as a disavowal of claim scope.

### SUMMARY

In accordance with at least one form of the present invention, there is provided a method of selling or offering for sale unaltered duplicate parts of multi-part print media. In at least one form, the method comprises providing a plurality of unaltered duplicate parts of the multi-part print media and identifying each of the unaltered duplicate parts to distinguish it from the other of said unaltered duplicate parts. The method further comprises establishing a selling price for each of the unaltered duplicate parts and offering for sale each of the unaltered duplicate parts apart from the other unaltered duplicate parts.

In accordance with at least one other general form of the present invention, there is provided a method of selling or offering for sale at least one unaltered duplicate part of multi-part print media, such as a magazine or newspaper that may contain, for example: Front Page, Business, Health, Opinion, etc., separate from that which is otherwise sold or offered for sale as a combined multi-part unit, whether independently/stand-alone, by a given market demand, targeted audience, targeted advertising or demographic profile.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the various forms of the present invention.

FIG. 1 is diagrammatical view of a current method of producing and selling printed media; and

FIG. 2 is a diagrammatical view of one form of a method of the present invention.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments of the present invention is defined solely by the claims. The features illustrated or described in connection with one exemplary embodiment may be combined with the features of other embodiments. Such modifications and variations are intended to be included within the scope of the present invention.

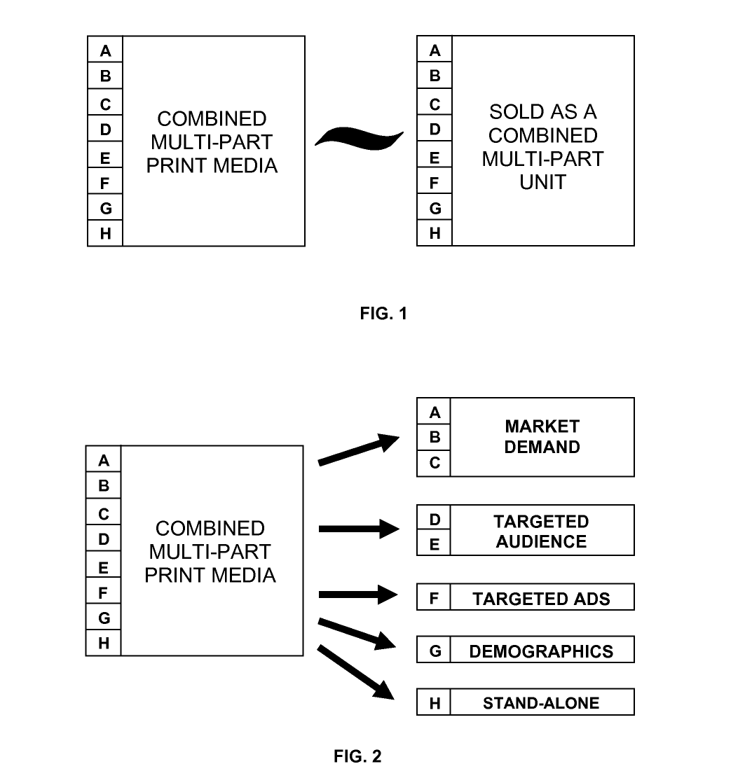

FIG. 1 illustrates in diagrammatic form the method employed in the past of manufacturing and selling printed media, such as, for example, a newspaper. The designations A-H in that Figure represent individual sections of the print media, such as the Front page, the Sports section, the Business section, the Living section, etc. Such approach requires the consumer to purchase the entire paper regardless of which section he or she is particularly interested. For example, if an individual desires to purchase the Sports section of the newspaper, he or she must purchase the entire paper. Such approach leads to waste and adds to the expense of the paper.

FIG. 2 illustrates one form of a method of the present invention for producing and selling Fractional Media. In one form, the unaltered media would be produced in such a manner to facilitate its separate sale apart from the whole. In various embodiments, each of the separate media sections would be separately identified for its individual sale as a stand-alone, unaltered or exact duplicate product. Such identification may comprise, for example, use of a barcode, an imprint, a label, sticker or other mark. For example, a sticker may be affixed around the open side of a folded newspaper section thus creating a single unit as delineated above that states (all or in part):

a) Buy This Section Now!

b) 50¢

c) Today's Sports Only (with date)

Supplying Fractional Media would be extremely cost-effective because it requires no change in printing technology, needs no new equipment, uses existing distribution channels, vending machines, racks, shelves, etc. It dramatically reduces raw materials by also reducing “dead-loss” (i.e. loss of income from damage or theft). It also opens up possibilities in customizable home delivery subscriptions, for example, again reducing waste because only the purchased section(s) needs packaging.

Sales revenue should increase because people are more likely to buy a given section simply because they want that section; it is further likely they will spend more to acquire several specific sections than for one whole undivided paper containing mostly stuff they will just discard. It is also possible some publishers could actually make money by selling just their Classified ads or Comics section.

The invention which is intended to be protected is not to be construed as limited to the particular embodiments disclosed. The embodiments are therefore to be regarded as illustrative rather than restrictive. Variations and changes may be made by others without departing from the spirit of the present invention. Accordingly, it is expressly intended that all such equivalents, variations and changes which fall within the spirit and scope of the present invention as defined in the claims be embraced thereby.

What is claimed is:

1. A method of selling or offering for sale unaltered duplicate parts of multi-part print media, comprising:
providing a plurality of unaltered duplicate parts of the multi-part print media;
identifying each of the unaltered duplicate parts to distinguish it from the other of said unaltered duplicate parts;
establishing a selling price for each of the unaltered duplicate parts; and
offering for sale each of the unaltered duplicate parts apart from the other unaltered duplicate parts.

2. The method of claim 1 wherein said multi-part printed media comprises printed media selected from the group of printed media consisting of newspapers, books, booklets and magazines.

3. The method of claim 1 wherein said identifying comprises applying distinguishing indicia on each said discrete section.

4. The method of claim 3 wherein said distinguishing indicia comprises indicia selected from the group of indicia consisting of a barcode, an imprint, a label, and a sticker.

5. The method of claim 1 wherein said identifying comprises identifying the discrete sections based on market demand.

6. The method of claim 1 wherein said identifying comprises identifying the discrete sections based on a target consumer group.

7. The method of claim 1 wherein said identifying comprises identifying the discrete sections by at least one targeted advertisement.

8. The method of claim 1 wherein said identifying comprises identifying the discrete sections by at least one demographic profile.

9. The method of claim 1 wherein said identifying comprises making a stand alone offer.

10. A method of selling or offering for sale at least one unaltered duplicate part of a form of multi-part print media, separate from that which is otherwise sold or offered for sale as a combined multi-part unit, by a given market demand, targeted audience, targeted advertising or demographic profile.

11. The method of claim 10 wherein the form of multi-part print media is selected from the group of multi-part print media consisting of the front page, the business section, the opinion section, the sports section, the health section and the local section of a newspaper.

12. A method comprising:
providing a form of multi-part print media that is sellable as a combined multi-part unit, wherein the multi-part print media at least includes at least two of the sections comprising:
a front page section, a business section, an opinion section, a sports section, a health section and a local section and wherein the method further comprises:
selling at least one of the sections apart from at least one of the other of the sections in an unaltered form.

13. A method of selling at least one unaltered duplicate part of multi-part print media, separate to that which is otherwise dispensed or offered for sale as a combined multi-part unit, comprising:
providing a vending machine capable of vending at least one unaltered duplicate part of the multi-part print media separate from that which is otherwise sold or offered for sale as a combined multi-part unit, and
vending said at least one of said unaltered duplicate part upon acceptance of a monetary medium into said vending machine.

14. The method of claim 13 wherein the multi-part print media comprises printed media selected from the group of printed media consisting of newspapers, books, booklets and magazines.

15. The method of claim 14 wherein the newspapers includes at least two of the unaltered duplicate parts comprising a front page section, a business section, an opinion section, a sports section, a health section and a local section.
